(19) United States
(12) Patent Application Publication
(10) Pub. No.: US 2024/0419649 A1
(43) Pub. Date: Dec. 19, 2024

(54) QUERY EXECUTION DURING SYNCHRONIZATION

(71) Applicant: INTERNATIONAL BUSINESS MACHINES CORPORATION, ARMONK, NY (US)

(72) Inventors: Reinhold Geiselhart, Rottenburg-Ergenzingen (DE); Felix Beier, Haigerloch (DE); Max Fabian Gilbert, Ludwigshafen am Rhein (DE); Knut Stolze, Hummelshain (DE)

(21) Appl. No.: 18/462,771

(22) Filed: Sep. 7, 2023

(30) Foreign Application Priority Data
Jun. 15, 2023 (GB) 2308928.7

(51) Int. Cl. G06F 16/22; G06F 16/2455

(52) U.S. Cl. CPC G06F 16/2282; G06F 16/221; G06F 16/2455

(57) ABSTRACT

The present disclosure relates to a method for executing a query against a table of a database system, the table being configured to comprise records. The record comprises values of a set of columns, wherein one or more changes are being applied to the table in order to be synchronized with a corresponding table. The method comprises: receiving a query against the table, the query referencing one or more columns of the set of columns. It may be determined whether the application of one or more changes involving the one or more columns is completed. In response to determining that said one or more changes are applied, the query may be executed.

### BACKGROUND

The present disclosure relates to the field of digital computer systems, and more specifically, to a method for query execution in a database system.

Updates of data in a database are usually done in the scope of a transaction. This guarantees that other applications can only see consistent data. As soon as the transaction is committed, the set of updated data is consistent again and becomes visible to other applications. In addition, the updated set of data is written to the database log. This is done for several reasons, such as for crash recovery, archival purposes and as a source for replication. In consequence, in an environment of replicated databases, replication will then start with copying the data changes over to the target database. After some delay, the new data is then also visible to applications accessing the target database location. It may be important to guarantee that applications running either against the source database, or against the target database, always see the same data. For this, a feature “WAITFORDATA” has been introduced. It delays queries running against the target database long enough, until the same data, which a query running against the source side would see, has also become visible at the target database. However, this could prolong the wait time for queries running against the replication target significantly, since some data may take much more time to become visible at the target database.

### SUMMARY

Various embodiments provide a method for query execution in a database system, computer program product and database system as described herein. Advantageous embodiments are described in the following description. Embodiments of the present disclosure can be freely combined with each other if they are not mutually exclusive.

In one aspect, the disclosure relates to a method for executing a query against a table of a database system, the table being configured to comprise records comprising values of a set of columns, wherein one or more changes are being applied to the table in order to be synchronized with a corresponding table. The method comprises: receiving a query against the table, the query referencing one or more columns of the set of columns; determining whether an application of one or more specific changes of the changes is completed, the specific changes involving the one or more columns; in response to determining that the one or more specific changes are applied, executing the query.

In one aspect the disclosure relates to a computer program product comprising a computer-readable storage medium having computer-readable program code embodied therewith, the computer-readable program code configured to implement the method of the above embodiment.

In one aspect the disclosure relates to a database system for executing a query against a table of the database system, the table being configured to comprise records, the record comprising values of a set of columns, wherein one or more changes are being applied to the table in order to be synchronized with a corresponding table. The database system is configured for: receiving a query against the table, the query referencing one or more columns of the set of columns; determining whether the application of one or more changes involving the one or more columns is completed; in response to determining that said one or more changes are applied, executing the query.

### BRIEF DESCRIPTION OF THE DRAWINGS

In the following embodiments of the disclosure are explained in greater detail, by way of example only, making reference to the drawings in which:

FIG. 1A illustrates a diagram of a data analysis system in accordance with an example of the present subject matter.

FIG. 1B depicts a data layout of a source table in accordance with an example of the present subject matter.

FIG. 2 is a flowchart of a method for executing a query in accordance with an example of the present subject matter.

FIG. 3 is a flowchart of a method for executing a query in accordance with an example of the present subject matter.

FIG. 4 is a flowchart of a method for executing a query in accordance with an example of the present subject matter.

FIG. 5 is a flowchart of a method for executing a query in accordance with an example of the present subject matter.

FIG. 6 is a flowchart of a method for executing a query in accordance with an example of the present subject matter.

FIG. 7 is a flowchart of a method for executing a query in accordance with an example of the present subject matter.

FIG. 8 is a computing environment according to an example of the present subject matter.

### DETAILED DESCRIPTION

The descriptions of the various embodiments of the present disclosure will be presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

A database system (T_{DB}) may be provided. The database system T_{DB} may be configured to store data and enable access to the stored data. The database system T_{DB} may comprise a physical space for storing the data. For example, the physical space may be provided as a table space. The table space may represent a storage location where the actual data underlying database objects of the database system may be kept. The database object which occupies physical space may be table data and indexes. The physical space may be a set of volumes on disks that hold the data.

The present subject matter may enable an efficient query execution against a table (T₁) of the database system T_{DB}. The table T₁ may, for example, be provided as a replicated copy of a corresponding table T₀. The table T₁ comprises a set of columns (or attributes). The table T₁ may be synchronized with the table T₀. For that, changes which are applied to the table T₀ are replicated in order to be applied to the table T₁. This may enable to obtain a same copy of data in the two tables. The synchronization is performed so that the execution of a query at a time to against the table T₁ may have to provide the same result if the query is executed at that same time to on the table T₀. That is, the query may see consistent data in both tables.

The present subject matter may efficiently execute the query against the table T₁ as it may not wait for the whole table T₁ to be in a consistent state with the corresponding table T₀. This may speed up the query execution in the database system. For example, a query (Q₀) may be received at the database system. At the time of receiving the query Q₀. the table T₁ is being updated or synchronized with the table T₀ by application of a set of one or more changes to the table T₁. The set of one or more changes being applied to the table T₁ may be named an initial set SET0. Upon receiving the query, it may first be determined which columns of the table T₁ are referenced by the query. For example, the received query Q₀ may reference a first subset of columns of the set of columns of the table T₁ e.g., and the received query Q₀ does not use the remaining second subset of columns of the table T₁. In this case, the present method may identify one or more specific changes of the initial set SET0 that involve at least one column of said first subset of columns. The identified specific one or more changes may be named set SET1.

Instead of waiting for all changes of the initial set SET0 to be completed in order to execute the query Q₀ as it is the case with conventional methods, the present method may only wait for the completion of said specific changes of the set SET1.

The change of the SET1 is said to be completed in case the execution of the computer program that implements the change is completed and ended. Alternatively, in case a change X of the set SET1 involves the first subset of columns but also involves a column of the second subset of columns, the present method may only wait for the change X to be completed for the first subset of columns regardless of whether the change X to the column of the second subset is completed. This may particularly be advantageous because the query Q₀ does not use the second subset of columns.

According to one example, the set of specific changes SET1 may be the initial set of changes SET0. In this case, the present method may assume that all changes of SET0 being applied to the table T₁ involve the first subset of columns. This may be advantageous as there may be no need to select or identify the specific changes of SET1. This may save processing resources as most of the changes of a table involve all columns.

The change of the table T₁ may comprise a deletion of a record of the table T₁. wherein the deleted record may be referred to as delete record herein. In this case, the change is said to involve a delete record. Alternatively, the change may comprise an insertion of a record in the table T₁, wherein the inserted record may be referred to as insert record herein. In this case, the change is said to involve an insert record. Alternatively, the change may comprise an update of an existing record in the table T₁, wherein the update may comprise deletion of said existing record and insertion of its respective updated record. In this case, the change is said to involve a pair of delete record and insert record.

In case the specific changes of the set SET₁ are not completed for the first subset of columns, the method may wait for a predefined time period and then check again whether the specific changes of the set SET₁ are completed for the first subset of columns. If they are completed, the query Q₀ may be executed against the table T₁.

In one example, the columns of the table T₁ may comprise a subset of N1 first columns and a subset of N2 second columns, where N1 is the number of first columns which is higher than or equal to one, N1≥1 and N2 is the number of second columns which is higher than or equal to one, N2≥1. The first columns represent first attributes respectively. The first attributes may be of a first data type. The first data type may comprise a regular data type such as INTEGER type, CHAR type etc. The first attributes may, for example, comprise an ID attribute, a name attribute, an age attribute etc. The second columns represent second attributes respectively. The second attributes may be of a second data type. The second data type may comprise a large object (LOB) data type such as BLOB type, CLOB type, NCLOB type, BFILE type etc. The second attributes may, for example, comprise a video file, image, graphic etc. The first columns may thus be referred to as regular columns and the second columns may be referred to as LOB columns. The values of the first attributes may be referred to as regular values and the values of the second attributes may be referred to as LOB values. Thus, the table T₁ may comprise rows (or records), wherein each row has N1+N2 values of the N1 first columns and of the N2 second columns respectively. The first data type is different from the second data type. The second data type may have a maximum size higher than a maximum size of the first type data. For example, a LOB type can store up to 4 GB of data or more while a CHAR type may store up to e.g., to 1 GB of data; meaning that the LOB type (second data type) in this example has a maximum size of 4 GB and the CHAR type (first data type) has a maximum size of 1 GB.

The present method may advantageously be used in case of tables having LOB values. For that, according to one example, the method may be performed for the queries that reference the subset of N1 regular columns. That is, upon receiving the query Q₀, the present method may check whether the received query Q₀ references one or more columns of the N1 regular columns and does not use the LOB columns. That is, the method may be performed if the received query Q₀ reference regular columns and does not reference LOB columns.

This example may be advantageous because LOB data will take much more time to become visible (or replicated) at the database system. Thus, waiting for their associated change to be completed may prolong the wait time for queries running against the replication target significantly. This example may help to avoid very long blocking of queries when LOB data is involved in replication, but not needed by specific queries.

According to one example, the database system is configured to manage data in the table T₁ using a command processor. The database system T_{DB} may comprise the command processor that manages access to the table T₁. For example, the command processor may be configured to receive queries against the table T₁ and may execute the queries against the table T₁. For example, the command processor may be configured to return requested records of the table T₁. The command processor may be configured to block queries against the table T₁ during update of the table T₁. In this case, the received query Q₀ is blocked by the command processor until the application of all the changes of SET0 are completed. However, the present subject matter may prevent this by unblocking the query Q₀ once it is determined that the changes of set SET1 are completed for the first subset of columns referenced in the query Q₀. The unblocked query may then be executed.

The present subject matter may thus enable a seamless integration of the present subject matter in existing systems preventing a significant change to the existing systems while making use of the advantage of the present subject matter. Instead of blocking queries until all latest data of a committed transaction is visible at the target database system, the queries may be analyzed when blocking is getting into effect, and the data types which may be accessed are analyzed. If the specific queries do not access LOB data at all (and while LOB data, which might have been changed in same transaction as the regular data is still being copied), these queries may be unblocked and run.

The present example may selectively modify the lock mechanism for incoming queries which want to access the target database. By further analysis of the queries the type of data which will be accessed can be retrieved. If the specific query does not access LOB data, which might still be in the replication/copy phase, while all other “regular” data pieces are updated and consistent already at the target database, these queries are not blocked any longer but are allowed to access the regular data.

In one example, the method comprises checking whether the received query Q₀ is blocked by the command processor and in case it is blocked, the present method may be performed in order to identify and check whether the changes of the set SET1 are completed and execute the query Q₀ if they are completed.

According to one example, the database system T_{DB} is configured to apply the initial set of changes SET0 to the target table T₁ in accordance with a predefined order. The present method may further speed up the query execution by changing the order of application of the changes of set SET0 such that the specific changes of SET1 are given higher priority of application. This may enable to quickly execute the query Q₀.

In one example, the priority may change only in case the query Q₀ references a column of the second type. In this case, the column of the second type of the query is given higher priority than the other columns. This example may enable further optimization to shorten the wait time of queries which need to access LOB data at the target database. The order of LOBs to be replicated to the target database can be optimized and rescheduled, depending on queries waiting for the LOB data to show up at the target database.

In one example, the database system T_{DB} is a target database system of a data analysis system. The data analysis system comprises a source database system (S_{DB}). The table T₁ is a target table of the target database system T_{DB} which is associated with source table T₀ of the source database system S_{DB}. The data analysis system may, for example, be a data warehousing system or master data management system. The data analysis system may enable data warehousing or master data management or another technique that uses source and target database systems, wherein the target database system comprises a target database that is configured to receive/comprise a copy of a content of a corresponding source database of the source database system. The source database system S_{DB} may, for example, be a transactional engine and the target database system T_{DB} may be an analytical engine. For example, the source database system S_{DB} may be an online transaction processing (OLTP) system and the target database system T_{DB} may be an online analytical processing (OLAP) system. The source database system S_{DB} may comprise a source dataset and the target database system T_{DB} may comprise a target dataset. The source dataset may be part of a source database and the target dataset may be part of a target database. The source dataset may comprise tables, referred to as source tables, and the target dataset may comprise corresponding target tables. The content of the source dataset may be changed by one or more database transactions. The data analysis system may be configured to synchronize the content of the source tables of the source database system with the corresponding target tables of the target database system. For example, the present method may be performed for synchronization of data in the source database system S_{DB} with data in the target database system T_{DB}. This may enable to have the same data (of the table T₀) present in the source database system S_{DB} and the target database system T_{DB}.

The data analysis system may comprise a replication system that is configured for replicating changes of the source table T₀ to the target table T₁ using logfiles. The replication system may use conventional techniques, such as recovery log-based replication for replicating the changes using the logfile. The replication system may, for example, be the Change Replication System. The Change Replication System may be responsible for synchronizing the data state of the target database system with the data state of the source database system.

According to one example, the synchronization of the table T₁ with the corresponding table in the source database system S_{DB} may comprise receiving by the database system T_{DB} a latest committed data change, wherein determining whether the changes of SET1 are completed may comprise determining whether all replicated data of the first subset of columns referenced in the query satisfy the latest committed data change.

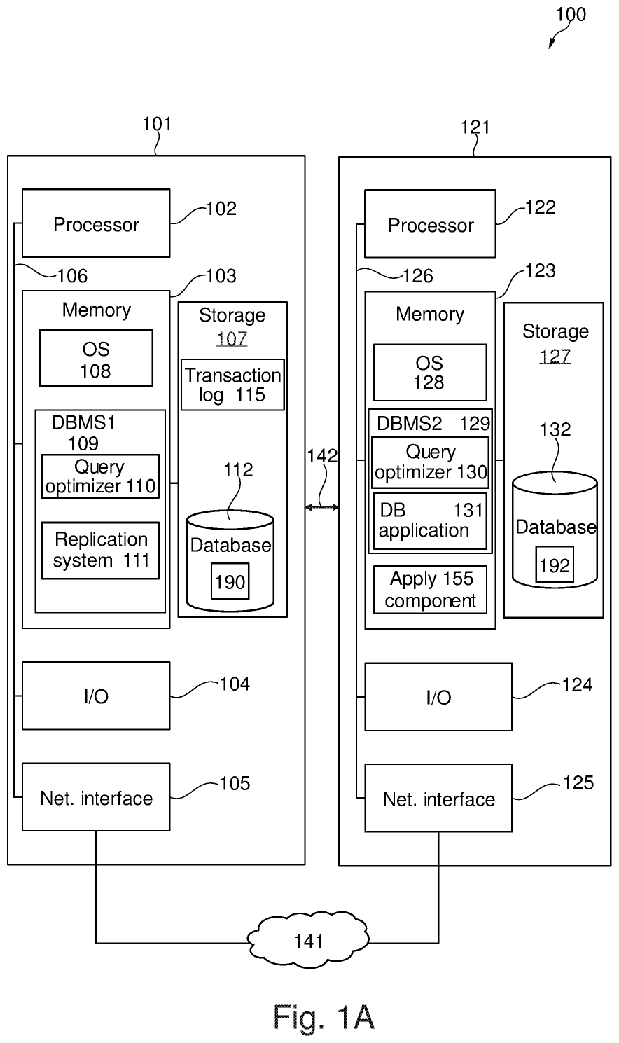

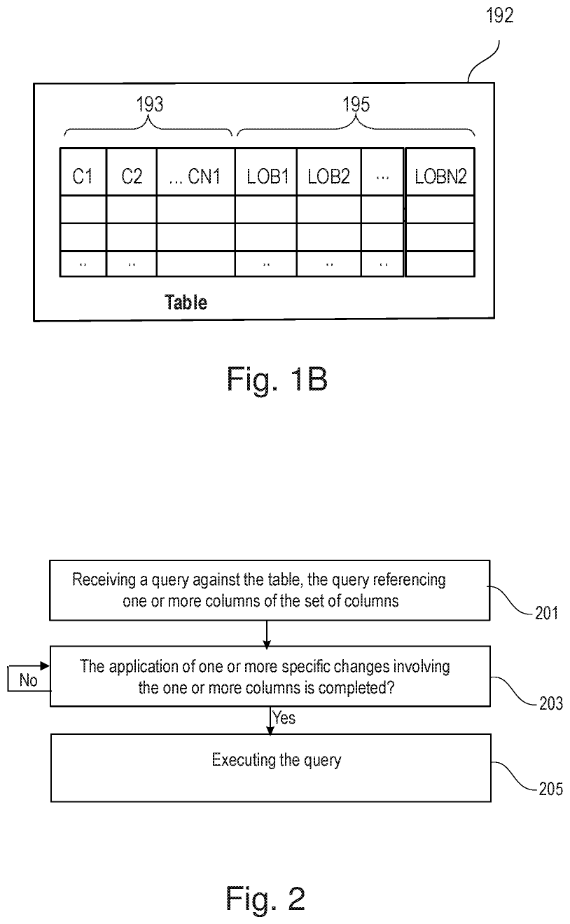

FIG. 1A is a block diagram for a data analysis system in accordance with an example of the present subject matter. The data analysis system 100 may, for example, comprise IBM Db2 Analytics Accelerator for z/OS (IDAA). The data analysis system 100 comprises a source database system 101 connected to a target database system 121. The source database system 101 may, for example, comprise IBM Db2 for z/OS. The target database system 121 may, for example, comprise IBM Db2 Warehouse (Db2 LUW).

Source database system 101 includes processor 102, memory 103, I/O circuitry 104 and network interface 105 coupled together by bus 106.

Processor 102 may represent one or more processors (e.g., microprocessors). The memory 103 can include any one or combination of volatile memory elements (e.g., random access memory (RAM, such as DRAM, SRAM, SDRAM, etc.)) and non-volatile memory elements (e.g., ROM, erasable programmable read only memory (EPROM), electronically erasable programmable read only memory (EEPROM), programmable read only memory (PROM). Note that the memory 103 can have a distributed architecture, where various components are situated remote from one another, but can be accessed by the processor 102.

Memory 103 in combination with persistent storage device 107 may be used for local data and instruction storage. Storage device 107 includes one or more persistent storage devices and media controlled by I/O circuitry 104. Storage device 107 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROM, DVD-ROMs, BD-ROMs, floppy disks, and the like. The storage 107 may comprise a first database 112. The first database 112 may, for example, comprise one or more first tables 190. FIG. 1B shows an example source table of the tables 190 as stored in the Source database system 101.

Memory 103 may include one or more separate programs e.g., database management system DBMS1 109, each of which comprises an ordered listing of executable instructions for implementing logical functions, notably functions involved in embodiments of this disclosure. The software in memory 103 shall also typically include a suitable operating system (OS) 108. The OS 108 essentially controls the execution of other computer programs for implementing at least part of methods as described herein. DBMS1 109 comprises a replication system 111 and a query optimizer 110. The replication system 111 may comprise a log reader (not shown). The log reader may read log records (also referred to as log entries) of a transaction recovery log 115 of the source database system 101 and provide changed records to the target database system 121. The usual content of a log record may comprise a timestamp, log record sequence number (LRSN) and attribute changes. More specifically, the log records in the transaction recovery log 115 may, for example, contain information defining (1) the table being changed, (2) the value of the key column in the row being changed, (3) the old and new values of all columns of the changed row, and (4) the transaction (unit of work) causing the change. By definition, an insert is a new data record and therefore has no old values. For delete changes, there is by definition no new data record, only an old data record. Thus, log records for inserted rows may contain only new column values while transaction log records for deleted rows may contain only old column values. Log records for updated rows may contain the new and old values of all row columns. The order of log records in the recovery log 115 may reflect the order of change operations of the transactions and the order of transaction commit records may reflect the order in which transactions are completed. The type of row operations in log records can, for example, be delete, insert or update. The log reader may read log records from the recovery log, extract relevant modification or change information (inserts/updates/deletes targeting tables in replication). Extracted information may be transmitted (e.g., as a request for application of the change) to target database system 121. The query optimizer 110 may be configured for generating or defining query plans for executing queries e.g., on first database 112.

Target database system 121 includes processor 122, memory 123, I/O circuitry 124 and network interface 125 coupled together by bus 126.

Processor 122 may represent one or more processors (e.g., microprocessors). The memory 123 can include any one or combination of volatile memory elements (e.g., random access memory (RAM, such as DRAM, SRAM, SDRAM, etc.)) and non-volatile memory elements (e.g., ROM, erasable programmable read only memory (EPROM), electronically erasable programmable read only memory (EEPROM), programmable read only memory (PROM). Note that the memory 123 can have a distributed architecture, where various components are situated remote from one another, but can be accessed by the processor 122.

Memory 123 in combination with persistent storage device 127 may be used for local data and instruction storage. Storage device 127 includes one or more persistent storage devices and media controlled by I/O circuitry 124. Storage device 127 may include magnetic, optical, magneto optical, or solid-state apparatus for digital data storage, for example, having fixed or removable media. Sample devices include hard disk drives, optical disk drives and floppy disks drives. Sample media include hard disk platters, CD-ROMs, DVD-ROMs, BD-ROMs, floppy disks, and the like.

Memory 123 may include one or more separate programs e.g., database management system DBMS2 129 and apply component 155, each of which comprises an ordered listing of executable instructions for implementing logical functions, notably functions involved in embodiments of this disclosure. The software in memory 123 shall also typically include a suitable OS 128. The OS 128 essentially controls the execution of other computer programs for implementing at least part of methods as described herein. DBMS2 129 comprises a DB application 131 and a query optimizer 130. The DB application 131 may be configured for processing data stored in storage device 127. The query optimizer 130 may be configured for generating or defining query plans for executing queries e.g., on a second database 132. The second database 132 may comprise a table 192 that provides a copy of the table 190. The apply component 155 may apply received changes to the second database 132. The apply component 155 may buffer log records sent from the log reader and consolidate the changes into batches to improve efficiency when applying the modifications to the second database 132 via a bulk-load interface. This may enable to perform replication.

Source database system 101 and target database system 121 may be independent computer hardware platforms communicating through a high-speed connection 142 or a network 141 via network interfaces 105, 125. The network 141 may, for example, comprise a local area network (LAN), a general wide area network (WAN), and/or a public network (e.g., the Internet). Each of the source and target database systems 101 and 121 may be responsible for managing its own copies of the data.

Although shown in FIG. 1A as separate systems, the source and target database systems may belong to a single system e.g., sharing a same memory and processor hardware, while each of the source and target database systems is associated with a respective DBMS and datasets e.g., the two DBMSs may be stored in the shared memory. In another example, the two database management systems DBMS1 and DBMS2 may form part of a single DBMS that enables communications and method performed by DBMS1and DBMS2 as described herein. The first and second datasets may be stored on a same storage or on separate storages.

FIG. 1B depicts a diagram illustrating the table 192 as stored in the target database system 121. The table 192 comprises a first set of columns 193 referred to as regular columns. The table 192 further comprises a second set of columns 195 referred to as LOB columns.

FIG. 2 is a flowchart of a method for executing queries in a database system in accordance with an example of the present subject matter. For the purpose of explanation, the method described in FIG. 2 may be implemented in the system illustrated in FIG. 1A-B, but is not limited to this implementation. For example, the method of FIG. 2 may be performed by the target database system 121 for executing queries against the table 192 shown in FIG. 1B. One or more changes are being applied to the table e.g., 192, in order to be synchronized with the corresponding table e.g., 190.

A query against the table 192 may be received in step 201. The query references one or more columns of the set of columns of the table 192. It may be determined in step 203 whether the application of one or more specific changes of the changes is completed, wherein the specific changes involve the one or more columns. In response to determining that the one or more specific changes are applied, the query may be executed in step 205. In response to determining that the one or more specific changes are not completely applied, step 203 may be repeated.

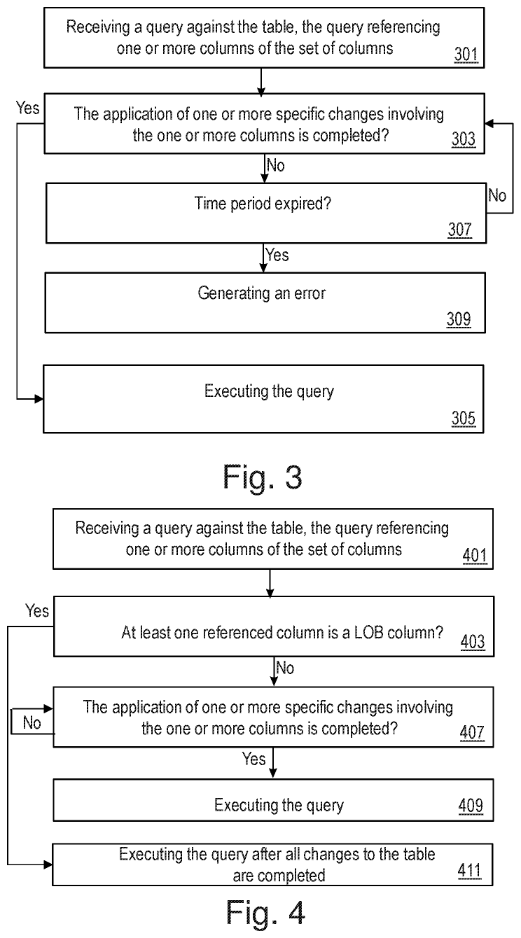

FIG. 3 is a flowchart of a method for reading a table in a database system in accordance with an example of the present subject matter. For the purpose of explanation, the method described in FIG. 3 may be implemented in the system illustrated in FIGS. 1A-B, but is not limited to this implementation. For example, the method of FIG. 3 may be performed by the target database system 121. One or more changes are being applied to the table e.g., 193, in order to be synchronized with a corresponding table e.g., 190.

A query against the table 192 may be received in step 301. The query references one or more columns of the set of columns of the table 192. It may be determined in step 303 whether the application of one or more specific changes of the changes is completed, wherein the specific changes involve the one or more columns. In response to determining that the one or more specific changes are applied, the query may be executed in step 305. In response to determining that the one or more specific changes are not completely applied, the method may wait for a time period and determine in step 307 whether the time period is expired. If the time period is expired an error may be generated in step 309. The error may be sent to the sender of the query. If the time period is not expired the method goes back to step 303.

FIG. 4 is a flowchart of a method for executing queries in a database system in accordance with an example of the present subject matter. For the purpose of explanation, the method described in FIG. 4 may be implemented in the system illustrated in FIGS. 1A-B, but is not limited to this implementation. For example, the method of FIG. 4 may be performed by the target database system 121 for executing queries against the table 192 shown in FIG. 1B. One or more changes are being applied to the table e.g., 193, in order to be synchronized with a corresponding table e.g., 190.

A query against the table 192 may be received in step 401. The query references one or more columns of the set of columns of the table 192. It may be determined in step 403 whether at least one of the referenced columns is a LOB column. In case the referenced column is a LOB column, the query may be executed in step 411 using the command processor (as usual), by waiting until all changes being applied to the table 192 are completed and only then executing the query. In case no LOB column is referenced performing steps 407 to 409. It may be determined in step 407 whether the application of one or more specific changes of the changes is completed, wherein the specific changes involve the one or more columns. In response to determining that the one or more specific changes are applied, the query may be executed in step 409. In response to determining that the one or more specific changes are not completely applied, step 407 may be repeated.

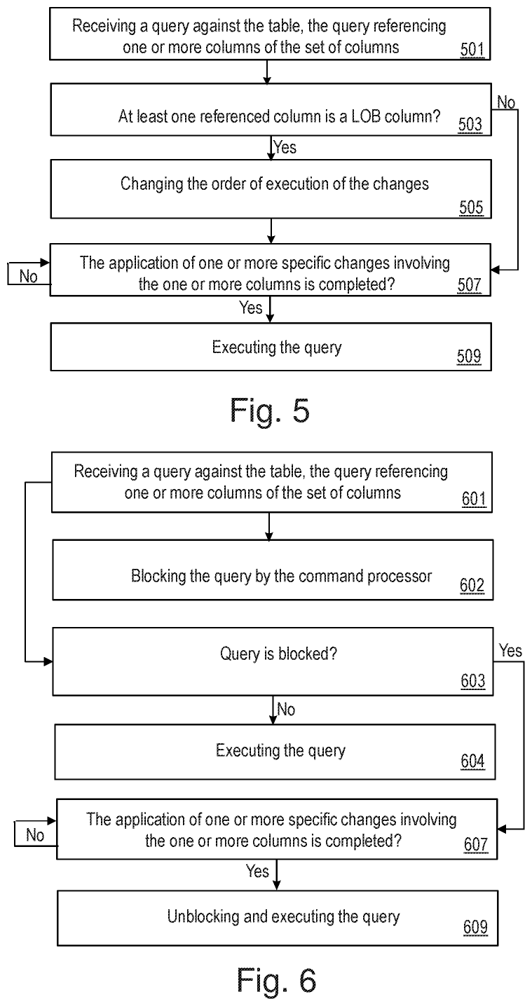

FIG. 5 is a flowchart of a method for executing queries in a database system in accordance with an example of the present subject matter. For the purpose of explanation, the method described in FIG. 5 may be implemented in the system illustrated in FIGS. 1A-B, but is not limited to this implementation. For example, the method of FIG. 5 may be performed by the target database system 121 for executing queries against the table 192 shown in FIG. 1B. One or more changes are being applied to the table e.g., 193, in order to be synchronized with a corresponding table e.g., 190.

A query against the table 192 may be received in step 501. The query references one or more columns of the set of columns of the table 192. It may be determined in step 503 whether at least one of the referenced columns is a LOB column. In case the referenced column is a LOB column, the order of execution of the changes is changed in step 505. In case no LOB column is referenced steps 507 to 509 may be performed. It may be determined in step 507 whether the application of one or more specific changes of the changes is completed, wherein the specific changes involve the one or more columns. In response to determining that the one or more specific changes are applied, the query may be executed in step 509. In response to determining that the one or more specific changes are not completely applied, step 507 may be repeated.

FIG. 6 is a flowchart of a method for executing queries in a database system in accordance with an example of the present subject matter. For the purpose of explanation, the method described in FIG. 6 may be implemented in the system illustrated in FIGS. 1A-B, but is not limited to this implementation. For example, the method of FIG. 6 may be performed by a component of the target database system 121 which is different from the command processor for executing queries against the table 192 shown in FIG. 1B.

A query against the table 192 may be received in step 601 at the command processor. The query references one or more columns of the set of columns of the table 192. The command processor may block in step 602 the query if the changes are not completed.

It may be determined in step 603 whether the query is blocked. In case the query is blocked steps 607 to 609; otherwise, the query may be executed in step 604. It may be determined in step 607 whether the application of one or more specific changes of the changes is completed, wherein the specific changes involve the one or more columns. In response to determining that the one or more specific changes are applied, the query may be unblocked and executed in step 609. In response to determining that the one or more specific changes are not completely applied, step 607 may be repeated.

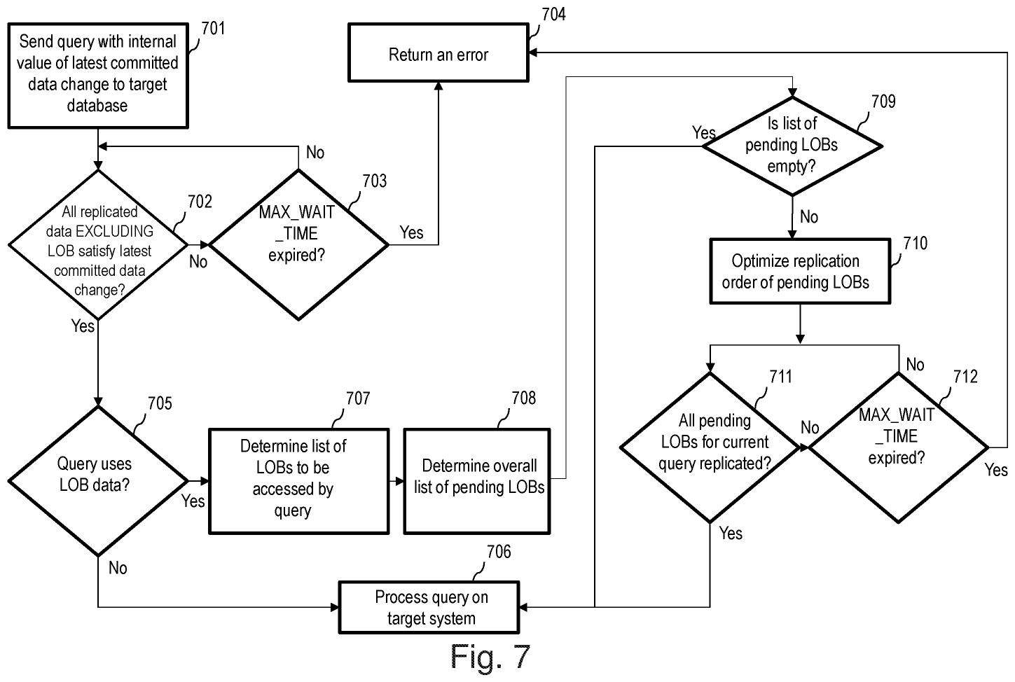

FIG. 7 is a flowchart of a method for executing queries in a database system in accordance with an example of the present subject matter. For the purpose of explanation, the method described in FIG. 7 may be implemented in the system illustrated in FIGS. 1A-B, but is not limited to this implementation. For example, the method of FIG. 7 may be performed by the target database system 121 for executing queries against the table 192 shown in FIG. 1B.

A query with internal value of latest committed data change of the table may be sent to the target database system in step 701. The table comprise LOB columns and regular columns. It may be determined (step 702) whether all replicated data excluding LOB data satisfy the latest committed data change.

In case all replicated data excluding LOB data do not satisfy the latest committed data change. It may be determined in step 703 whether a waiting time period MAX_WAIT_TIME is expired. In case the waiting time period is expired an error may be returned in step 704; otherwise, the method goes back to step 702.

In case all replicated data excluding LOB data do satisfy the latest committed data change, it may be determined in step 705 whether the query uses LOB data. In case the query does not use the LOB data the query may be processed in step 706 in the target database system.

In case the query uses the LOB data, the list of LOBs to be accessed by the query may be determined in step 707. In addition, the overall list of pending LOBs may be determined in step 708. It may be determined in step 709 whether the list of pending LOBs is empty. In case the list of pending LOBs is empty, the query may be processed in step 706 in the target database system. In case the list of pending LOBs is not empty, the replication order of pending LOBs may be optimized in step 710. The list of LOBs which are currently scheduled for replication may be re-arranged depending on the list of LOBs of blocked queries, which are waiting on them. As a result, those LOBs may be replicated first where queries are already waiting for them to become available (or have a higher priority).

It may be determined in step 711 whether all pending LOBs of the current query are replicated. In case all pending LOBs of the current query are replicated the query may be processed in step 706 in the target database system. In case all pending LOBs of the current query are not replicated, it may be determined in step 712 whether the waiting time period MAX_WAIT_TIME is expired. In case the waiting time period is expired an error may be returned in step 704; otherwise, the method goes back to step 711.

The present subject matter may comprise the following clauses.

Clause 1. A method for executing a query against a table of a database system, the table being configured to comprise records comprising values of a set of columns, wherein one or more changes are being applied to the table in order to be synchronized with a corresponding table, the method comprising: receiving a query against the table, the query referencing one or more columns of the set of columns; determining whether an application of one or more specific changes of the changes is completed, the specific changes involving the one or more columns; in response to determining that the one or more specific changes are applied, executing the query.

Clause 2. The method of clause 1, the set of columns comprising one or more first columns and one or more second columns, the first columns being configured for comprising first type data, the second columns being configured for comprising second type data, wherein the second type data has a maximum size higher than a maximum size of the first type data, wherein the method is performed in response to determining that the referenced one or more columns are first columns.

Clause 3. The method of clause 2, further comprising: in response to determining that the referenced one or more columns comprise one or more of the second columns, waiting until all the changes being applied to the table are completed for executing the query.

Clause 4. The method of any of the preceding clauses 1 to 3, wherein the database system is configured to manage data in the table using a command processor, wherein the query is destined to the command processor, wherein the query is blocked by the command processor until the application of all the changes is completed, the execution of the query comprising: unblocking the query.

Clause 5. The method of any of the preceding clauses 1 to 4, the one or more specific changes being all changes being applied to the table.

Clause 6. The method of any of the preceding clauses 1 to 5, wherein in response to determining that said one or more changes are not completely applied, repeating the determining.

Clause 7. The method of any of the preceding clauses 4 to 6, wherein the determining and the execution are performed in response to determining that the query is blocked.

Clause 8. The method of any of the preceding clauses 1 to 7, wherein the changes are applied in accordance with a predefined order, the method further comprising: changing the order of application of the changes such that a higher priority is provided to the changes that involve the referenced one or more columns and applying the changes in accordance with the changed order.

Clause 9. The method of clause 8, the method being performed in response to determining that said one or more changes are not completely applied.

Clause 10. The method of clause 8, the method being performed if the referenced one or more columns of the query comprise one or more second columns.

Clause 11. The method of any of the preceding clauses 1 to 10, the method being performed in response to receiving a latest data committed change, wherein determining whether the application of one or more specific changes of the changes is completed comprises determining whether data of the referenced columns fulfils the latest data committed change.

Computing environment 1800 contains an example of an environment for the execution of at least some of the computer code involved in performing the disclosed methods, such as a query execution code 1900. In addition to block 1900, computing environment 1800 includes, for example, computer 1801, wide area network (WAN) 1802, end user device (EUD) 1803, remote server 1804, public cloud 1805, and private cloud 1806. In this embodiment, computer 1801 includes processor set 1810 (including processing circuitry 1820 and cache 1821), communication fabric 1811, volatile memory 1812, persistent storage 1813 (including operating system 1822 and block 1900, as identified above), peripheral device set 1814 (including user interface (UI) device set 1823, storage 1824, and Internet of Things (IoT) sensor set 1825), and network module 1815. Remote server 1804 includes remote database 1830. Public cloud 1805 includes gateway 1840, cloud orchestration module 1841, host physical machine set 1842, virtual machine set 1843, and container set 1844.

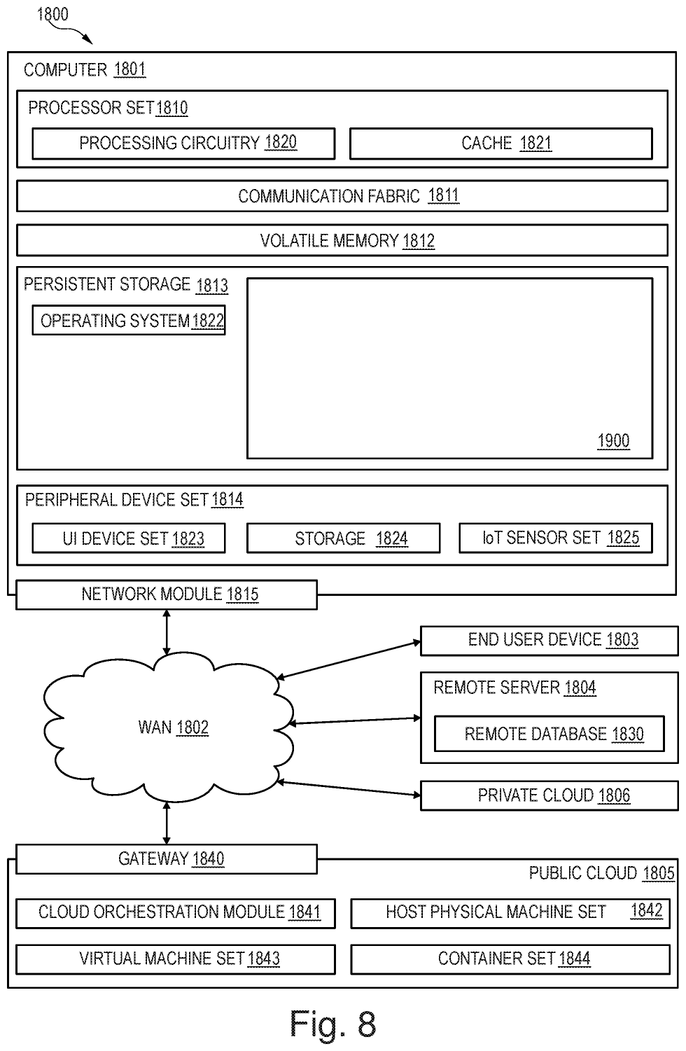

COMPUTER 1801 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1830. As is well understood in the art of computer technology, and depending upon the technology, performance of a computer-implemented method may be distributed among multiple computers and/or between multiple locations. On the other hand, in this presentation of computing environment 1800, detailed discussion is focused on a single computer, specifically computer 1801, to keep the presentation as simple as possible. Computer 1801 may be located in a cloud, even though it is not shown in a cloud in FIG. 8. On the other hand, computer 1801 is not required to be in a cloud except to any extent as may be affirmatively indicated.

PROCESSOR SET 1810 includes one, or more, computer processors of any type now known or to be developed in the future. Processing circuitry 1820 may be distributed over multiple packages, for example, multiple, coordinated integrated circuit chips. Processing circuitry 1820 may implement multiple processor threads and/or multiple processor cores. Cache 1821 is memory that is located in the processor chip package(s) and is typically used for data or code that should be available for rapid access by the threads or cores running on processor set 1810. Cache memories are typically organized into multiple levels depending upon relative proximity to the processing circuitry. Alternatively, some, or all, of the cache for the processor set may be located “off chip.” In some computing environments, processor set 1810 may be designed for working with qubits and performing quantum computing.

Computer readable program instructions are typically loaded onto computer 1801 to cause a series of operational steps to be performed by processor set 1810 of computer 1801 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 1821 and the other storage media discussed below. The program instructions, and associated data, are accessed by processor set 1810 to control and direct performance of the disclosed methods. In computing environment 1800, at least some of the instructions for performing the disclosed methods may be stored in block 1900 in persistent storage 1813.

COMMUNICATION FABRIC 1811 is the signal conduction path that allows the various components of computer 1801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 1812 is any type of volatile memory now known or to be developed in the future. Examples include dynamic type random access memory (RAM) or static type RAM. Typically, volatile memory 1812 is characterized by random access, but this is not required unless affirmatively indicated. In computer 1801, the volatile memory 1812 is located in a single package and is internal to computer 1801, but, alternatively or additionally, the volatile memory may be distributed over multiple packages and/or located externally with respect to computer 1801.

PERSISTENT STORAGE 1813 is any form of non-volatile storage for computers that is now known or to be developed in the future. The non-volatility of this storage means that the stored data is maintained regardless of whether power is being supplied to computer 1801 and/or directly to persistent storage 1813. Persistent storage 1813 may be a read only memory (ROM), but typically at least a portion of the persistent storage allows writing of data, deletion of data and re-writing of data. Some familiar forms of persistent storage include magnetic disks and solid state storage devices. Operating system 1822 may take several forms, such as various known proprietary operating systems or open source Portable Operating System Interface-type operating systems that employ a kernel. The code included in block 1900 typically includes at least some of the computer code involved in performing the disclosed methods.

PERIPHERAL DEVICE SET 1814 includes the set of peripheral devices of computer 1801. Data communication connections between the peripheral devices and the other components of computer 1801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1823 may include components such as a display screen, speaker, microphone, wearable devices (such as goggles and smart watches), keyboard, mouse, printer, touchpad, game controllers, and haptic devices. Storage 1824 is external storage, such as an external hard drive, or insertable storage, such as an SD card. Storage 1824 may be persistent and/or volatile. In some embodiments, storage 1824 may take the form of a quantum computing storage device for storing data in the form of qubits. In embodiments where computer 1801 is required to have a large amount of storage (for example, where computer 1801 locally stores and manages a large database) then this storage may be provided by peripheral storage devices designed for storing very large amounts of data, such as a storage area network (SAN) that is shared by multiple, geographically distributed computers. IoT sensor set 1825 is made up of sensors that can be used in Internet of Things applications. For example, one sensor may be a thermometer and another sensor may be a motion detector.

NETWORK MODULE 1815 is the collection of computer software, hardware, and firmware that allows computer 1801 to communicate with other computers through WAN 1802. Network module 1815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1815 are performed on the same physical hardware device. In other embodiments (for example, embodiments that utilize software-defined networking (SDN)), the control functions and the forwarding functions of network module 1815 are performed on physically separate devices, such that the control functions manage several different network hardware devices. Computer readable program instructions for performing the disclosed methods can typically be downloaded to computer 1801 from an external computer or external storage device through a network adapter card or network interface included in network module 1815.

WAN 1802 is any wide area network (for example, the internet) capable of communicating computer data over non-local distances by any technology for communicating computer data, now known or to be developed in the future. In some embodiments, the WAN 1802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 1803 is any computer system that is used and controlled by an end user (for example, a customer of an enterprise that operates computer 1801), and may take any of the forms discussed above in connection with computer 1801. EUD 1803 typically receives helpful and useful data from the operations of computer 1801. For example, in a hypothetical case where computer 1801 is designed to provide a recommendation to an end user, this recommendation would typically be communicated from network module 1815 of computer 1801 through WAN 1802 to EUD 1803. In this way, EUD 1803 can display, or otherwise present, the recommendation to an end user. In some embodiments, EUD 1803 may be a client device, such as thin client, heavy client, mainframe computer, desktop computer and so on.

REMOTE SERVER 1804 is any computer system that serves at least some data and/or functionality to computer 1801. Remote server 1804 may be controlled and used by the same entity that operates computer 1801. Remote server 1804 represents the machine(s) that collect and store helpful and useful data for use by other computers, such as computer 1801. For example, in a hypothetical case where computer 1801 is designed and programmed to provide a recommendation based on historical data, then this historical data may be provided to computer 1801 from remote database 1830 of remote server 1804.

PUBLIC CLOUD 1805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 1805 is performed by the computer hardware and/or software of cloud orchestration module 1841. The computing resources provided by public cloud 1805 are typically implemented by virtual computing environments that run on various computers making up the computers of host physical machine set 1842, which is the universe of physical computers in and/or available to public cloud 1805. The virtual computing environments (VCEs) typically take the form of virtual machines from virtual machine set 1843 and/or containers from container set 1844. It is understood that these VCEs may be stored as images and may be transferred among and between the various physical machine hosts, either as images or after instantiation of the VCE. Cloud orchestration module 1841 manages the transfer and storage of images, deploys new instantiations of VCEs and manages active instantiations of VCE deployments. Gateway 1840 is the collection of computer software, hardware, and firmware that allows public cloud 1805 to communicate through WAN 1802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 1806 is similar to public cloud 1805, except that the computing resources are only available for use by a single enterprise. While private cloud 1806 is depicted as being in communication with WAN 1802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 1805 and private cloud 1806 are both part of a larger hybrid cloud.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

1. A method for query execution in a database system, the method comprising:
receiving a query against a second table of the database system, wherein the second table of the database system is being updated or synchronized with a first table of the database system by applying a set of one or more changes to the second table at a time of receiving the query;
identifying a first subset of columns of the second table being referenced by the query;
identifying one or more specific changes of the set of one or more changes to the second table that involve at least one column of the first subset of columns; and
executing the query in response to completion of the one or more specific changes of the set of one or more changes to the second table thereby not waiting for an entirety of the second table to be in a consistent state with the first table.

2. The method of claim 1,
wherein a change of the one or more specific changes involves a first column of the first subset of columns as well as a second column of a second subset of columns, wherein the second subset of columns is not referenced by the query.

3. The method of claim 2, further comprising:
executing the query in response to completion of the change involving the first column of the first subset of columns and prior to completion of the change involving the second column of the second subset of columns.

4. The method of claim 2,
wherein the change comprises one of the following in the group consisting of:
a deletion of a record, an insertion of a record, and an update of an existing record.

5. The method of claim 1,
wherein the query references regular columns but does not reference large object columns in the second table.

6. The method of claim 1, further comprising:
blocking the received query until the one or more specific changes of the set of one or more changes to the second table are completed; and
unblocking the received query in response to completion of the one or more specific changes of the set of one or more changes to the second table.

7. The method of claim 1,
wherein completion of the one or more specific changes of the set of one or more changes to the second table occurs in response to all replicated data of the first subset of columns of the second table referenced in the query satisfying a latest committed data change.

8. A computer program product for query execution in a database system, the computer program product comprising one or more computer readable storage mediums having program code embodied therewith, the program code comprising programming instructions for:
receiving a query against a second table of the database system, wherein the second table of the database system is being updated or synchronized with a first table of the database system by applying a set of one or more changes to the second table at a time of receiving the query;
identifying a first subset of columns of the second table being referenced by the query;
identifying one or more specific changes of the set of one or more changes to the second table that involve at least one column of the first subset of columns; and
executing the query in response to completion of the one or more specific changes of the set of one or more changes to the second table thereby not waiting for an entirety of the second table to be in a consistent state with the first table.

9. The computer program product of claim 8,
wherein a change of the one or more specific changes involves a first column of the first subset of columns as well as a second column of a second subset of columns, wherein the second subset of columns is not referenced by the query.

10. The computer program product of claim 9,
wherein the program code further comprises the programming instructions for:
executing the query in response to completion of the change involving the first column of the first subset of columns and prior to completion of the change involving the second column of the second subset of columns.

11. The computer program product of claim 9,
wherein the change comprises one of the following in the group consisting of: a deletion of a record, an insertion of a record, and an update of an existing record.

12. The computer program product of claim 8, wherein the query references regular columns but does not reference large object columns in the second table.

13. The computer program product of claim 8, wherein the program code further comprises the programming instructions for:
blocking the received query until the one or more specific changes of the set of one or more changes to the second table are completed; and
unblocking the received query in response to completion of the one or more specific changes of the set of one or more changes to the second table.

14. The computer program product of claim 8, wherein completion of the one or more specific changes of the set of one or more changes to the second table occurs in response to all replicated data of the first subset of columns of the second table referenced in the query satisfying a latest committed data change.

15. A system, comprising:
a memory for storing a computer program for query execution in a database system; and
a processor connected to the memory, wherein the processor is configured to execute program instructions of the computer program comprising:
receiving a query against a second table of the database system, wherein the second table of the database system is being updated or synchronized with a first table of the database system by applying a set of one or more changes to the second table at a time of receiving the query;
identifying a first subset of columns of the second table being referenced by the query;
identifying one or more specific changes of the set of one or more changes to the second table that involve at least one column of the first subset of columns; and
executing the query in response to completion of the one or more specific changes of the set of one or more changes to the second table thereby not waiting for an entirety of the second table to be in a consistent state with the first table.

16. The system of claim 15,
wherein a change of the one or more specific changes involves a first column of the first subset of columns as well as a second column of a second subset of columns, wherein the second subset of columns is not referenced by the query.

17. The system of claim 16,
wherein the program instructions of the computer program further comprise:
executing the query in response to completion of the change involving the first column of the first subset of columns and prior to completion of the change involving the second column of the second subset of columns.

18. The system of claim 16,
wherein the change comprises one of the following in the group consisting of: a deletion of a record, an insertion of a record, and an update of an existing record.

19. The system of claim 15,
wherein the query references regular columns but does not reference large object columns in the second table.

20. The system of claim 15,
wherein the program instructions of the computer program further comprise:
blocking the received query until the one or more specific changes of the set of one or more changes to the second table are completed; and
unblocking the received query in response to completion of the one or more specific changes of the set of one or more changes to the second table.
